(19) United States
(12) Patent Application Publication
(10) Pub. No.: US 2023/0229930 A1
(43) Pub. Date: Jul. 20, 2023

(54) SYSTEMS AND METHODS FOR LOCALITY PRESERVING FEDERATED LEARNING

(71) Applicant: JPMORGAN CHASE BANK, N.A., New York, NY (US)

(72) Inventors: Antonios GEORGIADIS, London (GB); Fanny SILAVONG, London (GB); Sean MORAN, London (GB); Rob OTTER, Witham (GB)

(21) Appl. No.: 18/155,537

(22) Filed: Jan. 17, 2023

(30) Foreign Application Priority Data
Jan. 17, 2022 (GR) 20220100041

(51) Int. Cl. G06N 3/098

(52) U.S. Cl. CPC G06N 3/098

(57) ABSTRACT

Systems and methods for locality preserving federated learning are disclosed. In one embodiment, a method for locality preserving federated learning may include: (1) receiving, at an aggregator computer program and from each of a plurality of clients, weights for each client's local machine learning model; (2) generating, by the aggregator computer program, an averaged machine learning model based on the received weights; (3) sharing, by the aggregator computer program, the averaged machine learning model with the plurality of clients; and (4) applying, by each client, a scaling factor to the averaged machine learning model to update its local machine learning model.

### RELATED APPLICATIONS

This application claims priority to, and the benefit of, Green Patent Application No. 20220100041, filed Jan. 17, 2022, the disclosure of which is hereby incorporated, by reference, in its entirety.

### BACKGROUND OF THE INVENTION

### 1. Field Of The Invention

Embodiments generally relate to systems and methods for locality preserving federated learning.

### 2. Description of the Related Art

Machine Learning (ML) models typically require centralization of data before training. Moving data is expensive in resource effort, time and cost. Data sensitivity and privacy laws can be blockers to sharing.

One solution to this is Federated Learning (FL), which enables ML training to happen without having to reveal or move data from their original locations. Instead of data, only ML model updates are exchanged, thereby reducing the computational load of the main server as the ML is distributed to the clients. An aggregator learns by averaging ML models received from the clients and then “clobbering” the clients with the averaged model. This may lead, however, to clients being “trapped” in a sub-optimal local minima

“Clobbering” often provides sub-optimal results, especially when the number of clients and their variability increases.

In addition, because traditional learning rates in FL clients are very low, the clients no longer offer variability to the aggregator, meaning that the clients lose their individuality from very early epochs. Preserving client model variability to the aggregator means that more information can be extracted for longer. In the opposite case, the model gets stuck in an optimum and there is little gain in further iterations.

FIG. 1 provides an illustration of differences between the clients and the aggregator during the course of training. The graph shows the cosine similarity between the weights of the clients and the weights of the aggregator over federation epochs. As can be seen, all models converge to a line, and there is very little differentiation afterwards.

### SUMMARY OF THE INVENTION

Systems and methods for locality preserving federated learning are disclosed. In one embodiment, a method for locality preserving federated learning may include: (1) receiving, at an aggregator computer program, a plurality of client machine learning models, each client machine learning model from a different client; (2) selecting, by the aggregator computer program, a scaling factor; and (3) providing, by the aggregator computer program, a scaled update for each client machine learning model to the respective clients.

According to another embodiment, a method for locality preserving federated learning may include: (1) receiving, at an aggregator computer program and from each of a plurality of clients, weights for each client's local machine learning model; (2) generating, by the aggregator computer program, an averaged machine learning model based on the received weights; (3) sharing, by the aggregator computer program, the averaged machine learning model with the plurality of clients; and (4) applying, by each client, a scaling factor to the averaged machine learning model to update its local machine learning model.

In one embodiment, the scaling factor may be the same for each of the plurality of clients. In another embodiment, the scaling factor may vary for at least one of the plurality of clients. In another embodiment, the aggregator computer program may select the scaling factor. In another embodiment, each of the plurality of clients selects its scaling factor.

In one embodiment, each of the plurality of clients may select scaling factor using a brute force search, using a line search, etc.

In one embodiment, the method may also include identifying, by the aggregator computer program, one of the plurality of clients as a divergent client.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates exemplary differences between the clients and the aggregator during the course of training using a conventional approach;

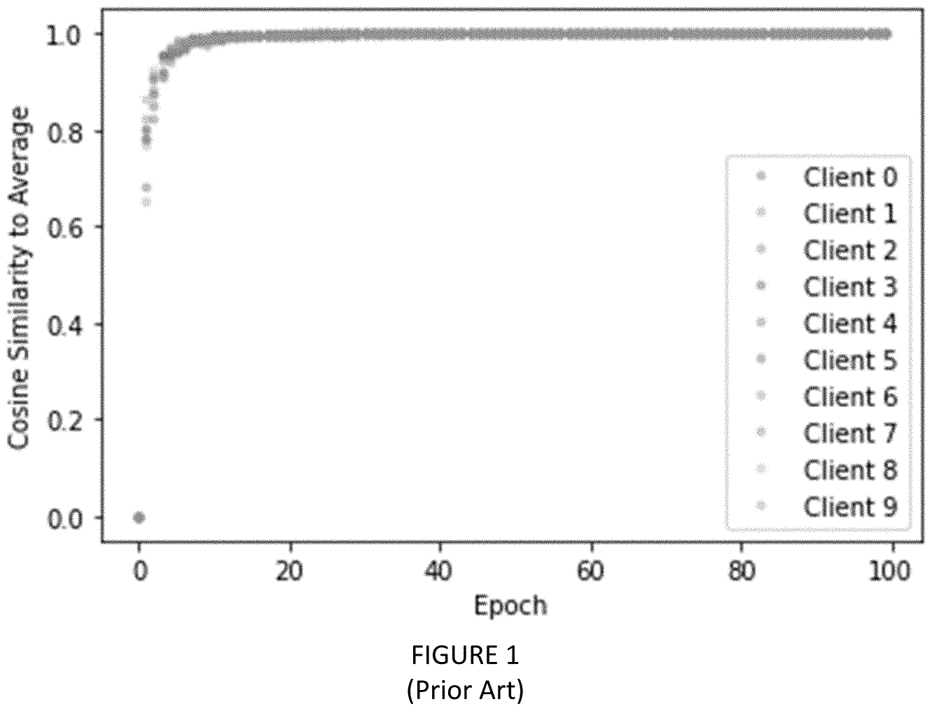

FIG. 2 illustrates exemplary differences between the clients and the aggregator during the course of training according to an embodiment;

FIG. 3 illustrates a comparison between the clobbering approach and the gradient approach of embodiments;

FIG. 4 depicts a system for locality preserving federated learning according to an embodiment;

FIG. 5 depicts a method for locality preserving federated learning is disclosed according to one embodiment; and

FIG. 6 depicts an exemplary computing system for implementing aspects of the present disclosure.

### DETAILED DESCRIPTION OF PREFERRED EMBODIMENTS

Embodiments may improve performance by allowing FL models to preserve their individuality for longer, resulting in a greater amount of knowledge that may be extracted from the clients. For example, each client's local models are not replaced with the aggregator's model. Because the aggregator's model tends to stay static in what the model extracts from the local data, by preserving the individuality of the local models, there is more “knowledge” (manifested as better gradients) that may be extracted from the local data. This leads to superior generalization, accuracy scores, and allows models to learn for longer.

Instead of replacing (or clobbering) the weights of all local models (denoted as “W_{client#}” for client #) with the aggregator's weights (denoted as Waggr), clients update their local models using a scaling factor (δ) such as: W′_{client#}=W_{client#}+δ(W_{aggr}-W_{client#}).

A zero-scaling factor (i.e., δ=0) means that only local training is happening on the clients, and the federation does not affect the client learning at all. A low scaling factor indicates that the aggregator affects the local model updates to a very small degree. A high scaling factor (i.e., δ=1), however, will push the client models very close to that of the aggregator. There may be one scaling factor for the entire federation (e.g., δ=0.5) that may be used with every client, or each client may have its own scaling factor. This may provide flexibility in that clients may be intelligently scaled with high individuality using different scaling factors.

The aggregator may learn from averaging and, instead of completely overwriting the client models, may “nudge” the weights of the client models towards the aggregator's model. For example, using scaled updates and the scaling factor (δ), each client's ML models are not replaced, but are instead nudged towards the average direction. Cosine similarity(Client weights, Aggregator) may be maximized, and the nudging may stop when there are no new significant updates between N-previous client updates and the current update. Embodiments may preserve client personalization.

In embodiments, tuning of the scaling factor may be automated. For example, an automatic approach for selecting the scaling factor may involve partitioning small parts of the local datasets on every client as validation sets; at every update cycle from the aggregator to the clients, the respective clients can create three temporary models locally, using different scaling factors (e.g., δ=[0.1, 0.5, 0.9]), and then test the different scaling factors on the validation sets. The model with the best results is kept for this iteration. This process may be repeated at every federated iteration. In addition, this approach can be extended through line search techniques.

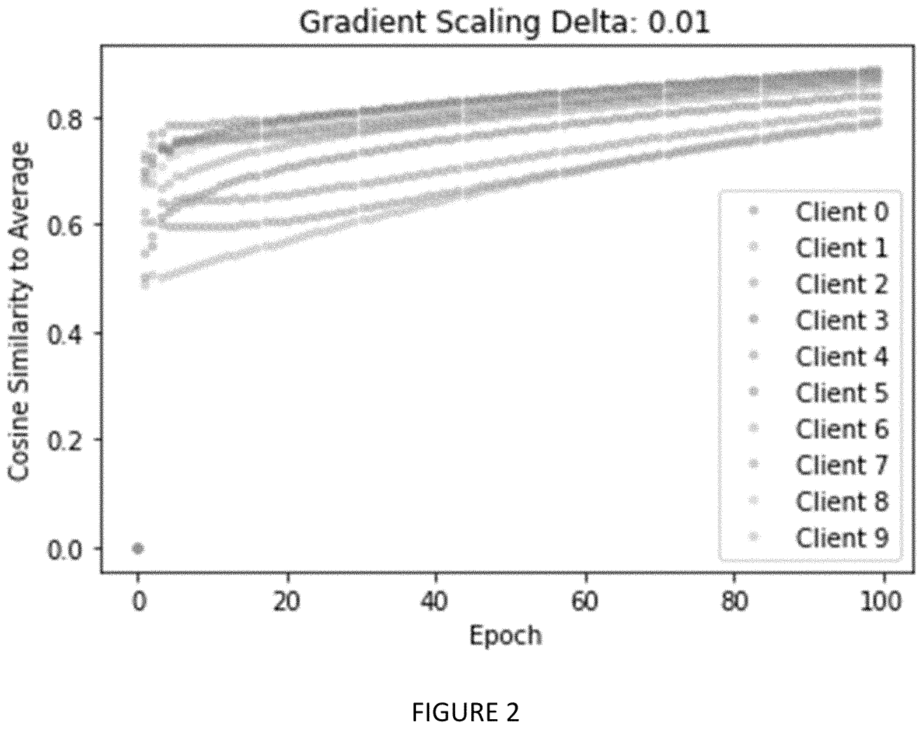

FIG. 2 illustrates differences between the clients and the aggregator during the course of training. As illustrated, using this dynamic approach disclosed herein, clients keep their individuality and keep learning for longer than with the clobbering approach.

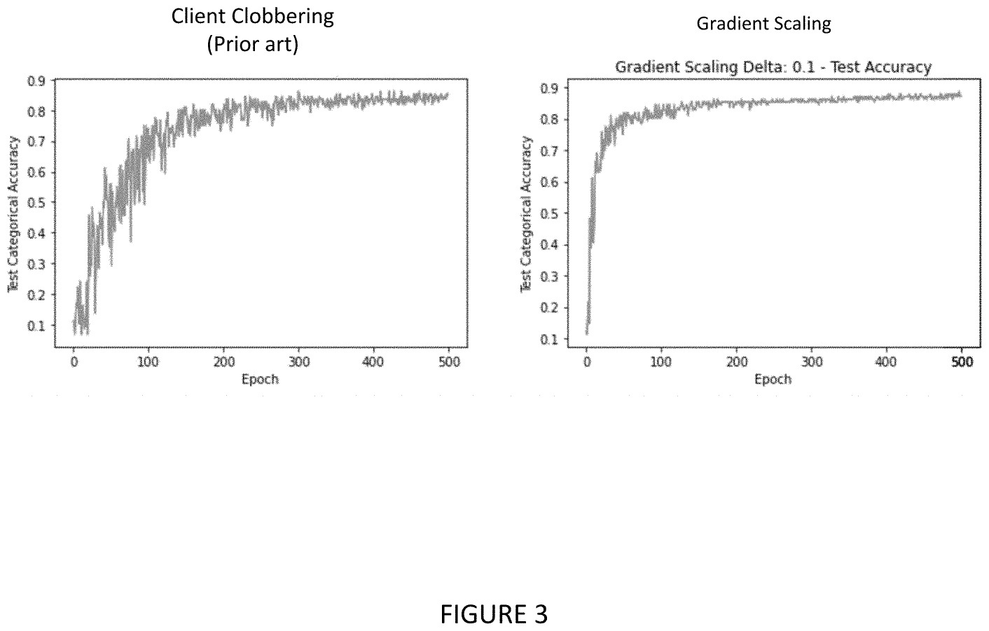

FIG. 3 illustrates a comparison between the clobbering approach and the gradient approach disclosed herein for the secret detection in source code task, MNIST (Modified National Institute of Standards and Technology) image classification (computer vision), and text generation using a pre-trained model. The gradient scaling approach is generalized better than the clobbering approach, which is prone to overfitting, and is more flexible than existing solutions as it can automatically determine the appropriate scaling factors. In embodiments, the automated selection of the scaling factor delta (as opposed to the manual setting) is a more user-friendly approach than manually analyzing data mathematically in order to choose a best delta.

Embodiments may further enhance the scaling heuristics using, for example, reinforcement learning, to choose the best scaling factor. Bayesian ML on client selection, gradient scaling, and optimal stopping, and may use reinforcement learning for optimal scaling per client.

Embodiments do not require the centralization of data before training ML models. This saves resources, time, and cost. In addition, because data is not moved, it cannot be blocked by data sensitivity and privacy laws. In addition, because updates to the ML models, and not data, are exchanged, the computational load is reduced as the ML processes are distributed among the clients.

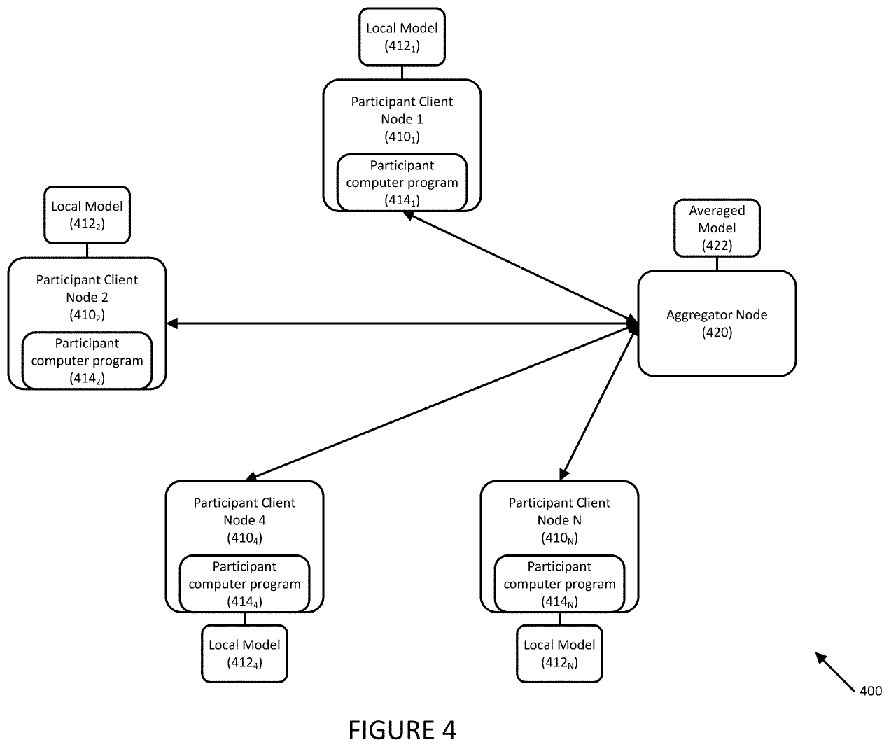

Referring to FIG. 4, a system for locality preserving federated learning is disclosed according to an embodiment. System 400 may include a plurality of participant client nodes 410 (e.g., 410₁, 410₂, 410₄, . . . 410_{N}), each of which may maintain local model 412 (e.g., 412₁, 412₂, 412₄, . . . 412_{N}). Each participant client node 410 may communicate with aggregator node 420.

Each node 410, 420 may execute participant node computer program 414 (e.g., 414₁, 414₂, 414₄, . . . 414_{N}), application, script, etc. (not shown) that may control operations of the respective node.

Each participant client node 410 may train its respective local mode 412 and may provide weights for its local model 412 to aggregator node 420. Aggregator node 420 may average the weights from participant client nodes 410, which defines averaged model 422. Aggregator node 420 may send weights for averaged model 422 to participant client nodes 410, which may retrain local models 412 using the weights.

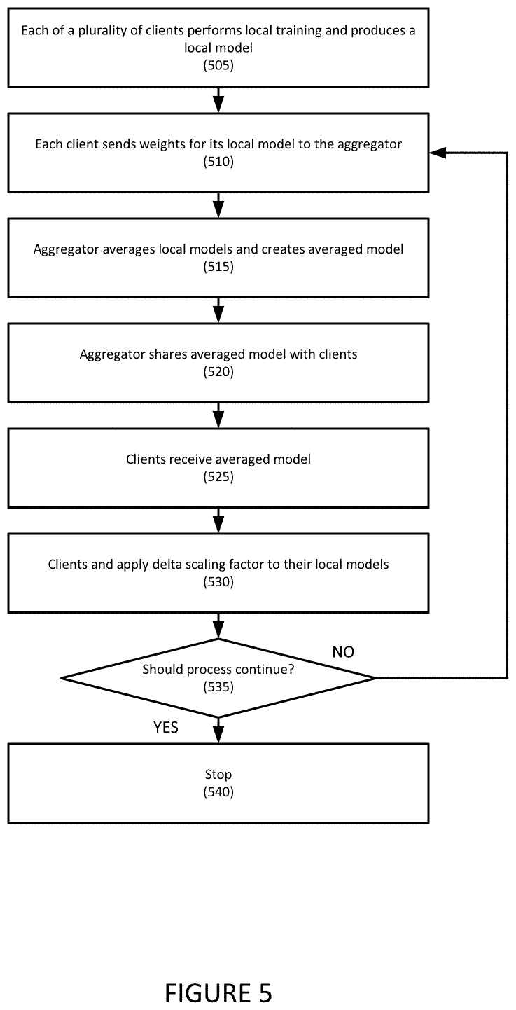

Referring to FIG. 5, a method for locality preserving federated learning is disclosed according to one embodiment.

Assuming there is no pre-trained model, in step 505, each of a plurality of clients performs training locally and produces its local model.

In step 510, each client may send the weights for its local model to the aggregator. For example, the local models and the averaged model may all have the same architecture, so only the weights are needed.

In one embodiment, if necessary, instead of sending the weights, the clients may send the local models to the aggregator. In another embodiment, the clients may send the local models and the weights to the aggregator.

In step 515, the aggregator may average the weights from the clients, which defines the aggregator's averaged model.

In step 520, the aggregator may share its averaged model with each of the clients. For example, the aggregator may send weights for the averaged models to the clients, or it may send the averaged model.

In step 525, the clients receive the weights for the averaged model or the averaged model, but do not replace their local models.

In step 530, the delta scaling factor determines how much to “nudge” the local models toward the aggregator's averaged model. For example, the delta scaling factor may have a universal value, an aggregator-driven value in which the aggregator sends a desired delta scaling factor to keep “divergent clients” diverse for longer, while still nudging them, or a client-driven value in which each client looks to maximize its local performance.

Divergent clients may influence the federation during the gradient aggregation. Non-divergent clients do not offer much new information compared to the previous aggregator model.

For example, gradient scaling may be applied to only divergent clients for computational efficiency.

For the universal value, the delta scaling factor may use a value such as 0.5, and all clients use the same delta scaling factor. The aggregator may communicate the value of the delta scaling factor to the clients with the averaged model. In one embodiment, clients may select to use either the universal, aggregator-driven approach or the client-driven approach. For example, in the universal approach, a flat 0.5 performs well in general and is a good default value. Alternatively, the clients may select a higher value if they suspect there may be “noisy” or poisoned clients in the federation and 0.5 is not enough to counteract the noise. In one embodiment, the clients may automatically increase the delta scaling factor in response to noise.

For the aggregator-driven approach, a cosine similarity between the client weights (or subset of them, for example, the weights in the last layer of a model) and the aggregators may be used, and the aggregator may determine which clients are diverse. Highly diverse clients (where the cosine similarity is equal or less than 0.5 to the aggregator) may keep their diversity while being gradually nudged. For those, a delta scaling factor of between 0.2 to 0.5 is acceptable, with default being 0.2.

For the client-driven approach, each client may select its delta scaling factor in an automated manner using its local validation set. The delta scaling factor that gives the best local validation score for that iteration is chosen.

This search for optimal delta scaling factor may be done by testing a fixed selection (e.g., 0.1, 0.5, 0.9), by brute force search (e.g., using a small step such as 0.1) or any other line search techniques.

Other approaches may be used as is necessary and/or desired.

In step 535, the aggregator may determine whether to continue the process. In embodiments, the process may continue until the whole federation has reached its end of training (i.e., there is no further improvement in the aggregator's validation testing which should happen every certain number of iterations (e.g., 5 iterations), or if the aggregator determines that the client's weights do not convey new information. The aggregator may pause communication with that client. This may occur when, for example, the client's gradient updates eventually are always the same for a number of iterations (e.g., 5 iterations), indicating that the local model is not updating because it has reached saturation or due to early stopping based on a local validation set.

If the aggregator determines that the process should stop, in step 540, the process may stop.

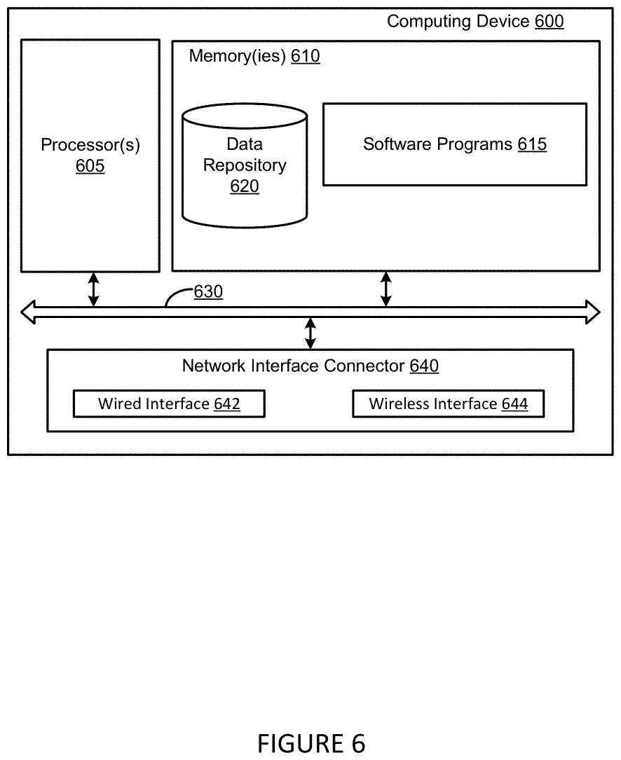

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for locality preserving federated learning, comprising:
receiving, at an aggregator node computer program at an aggregator node and from each of a plurality of participant clients, weights for each participant client's local machine learning model;
generating, by the aggregator node computer program, an averaged machine learning model based on the received weights;
sharing, by the aggregator node computer program, the averaged machine learning model with the plurality of participant clients; and
applying, by a participant node computer program executed by each participant client, a scaling factor to the averaged machine learning model to update its local machine learning model.

2. The method of claim 1, wherein the scaling factor is the same for each of the plurality of participant clients.

3. The method of claim 1, wherein the scaling factor varies for at least one of the plurality of participant clients.

4. The method of claim 1, wherein the aggregator computer program selects the scaling factor.

5. The method of claim 1, wherein each of the plurality of participant clients selects its scaling factor.

6. The method of claim 5, wherein each of the plurality of participant clients selects the scaling factor using a brute force search.

7. The method of claim 5, wherein each of the plurality of participant clients selects the scaling factor using a line search.

8. The method of claim 1, further comprising:
identifying, by the aggregator computer program, one of the plurality of participant clients as a divergent participant client.

9. A system, comprising:
an aggregator node executing an aggregator computer program and having an aggregated machine learning model; and
a plurality of participant client nodes, each participant client node associated with a client and executing a participant client computer program, each client having a local machine learning model;
wherein:
the participant client computer programs communicate weights for each client's local machine learning model to the aggregator computer program;
the aggregator computer program generates an averaged machine learning model based on the received weights;
the aggregator computer program shares the averaged machine learning model with the plurality of participant client computer program; and
each participant client computer program applies a scaling factor to the averaged machine learning model and updates its local machine learning model.

10. The system of claim 9, wherein the scaling factor is the same for each of the plurality of participant clients.

11. The system of claim 9, wherein the scaling factor varies for at least one of the plurality of participant clients.

12. The system of claim 9, wherein the aggregator computer program selects the scaling factor for the plurality of participant clients.

13. The system of claim 9, wherein each participant client computer program selects its scaling factor.

14. The system of claim 13, wherein each participant client computer program selects the scaling factor using a brute force search.

15. The system of claim 13, wherein each participant client computer program selects the scaling factor using a line search.

16. The system of claim 9, wherein the aggregator computer program identifies one of the plurality of participant clients as a divergent participant client.

17. A non-transitory computer readable storage medium, including instructions stored thereon, which when read and executed by one or more computer processors, cause the one or more computer processors to perform steps comprising:
receiving, from each of a plurality of participant clients, weights for each participant client's local machine learning model;
generating an averaged machine learning model based on the received weights; and
sharing the averaged machine learning model with the plurality of participant clients, wherein each participant client is configured to apply a scaling factor to the averaged machine learning model to update its local machine learning model.

18. The non-transitory computer readable storage medium of claim 17, wherein the scaling factor is the same for each of the plurality of participant clients.

19. The non-transitory computer readable storage medium of claim 17, wherein the scaling factor varies for at least one of the plurality of participant clients.

20. The non-transitory computer readable storage medium of claim 17, wherein the aggregator computer program selects the scaling factor for the plurality of participant clients.
